(19) United States
(12) Patent Application Publication
(10) Pub. No.: US 2024/0095829 A1
(43) Pub. Date: Mar. 21, 2024

(54) COMMUNICATION SYSTEM

(71) Applicant: Richard A Sapio, Dallas, TX (US)

(72) Inventor: Richard A Sapio, Dallas, TX (US)

(21) Appl. No.: 17/940,852

(22) Filed: Sep. 8, 2022

(51) Int. Cl. G06Q 40/06; G06Q 10/06

(52) U.S. Cl. CPC G06Q 40/06; G06Q 10/063

(57) ABSTRACT

A communication system is configured to enable node verification. The communication system comprising a company node further comprising a manager validation node communicatively coupled to a decision node. A special purpose acquisition company node is communicatively coupled to the decision node. An investment bank node is communicatively coupled to the decision node. The manager validation node prepares governance, an executive leadership team, audits, and a defensible business model which is communicated to the investment bank node as an offering request.

### BACKGROUND

The embodiments herein relate generally to communication systems.

Prior to embodiments of the disclosed invention, validation testing for various nodes in transaction verification occurred either at the node itself or at a central processor. This leads to poor packet routing and poor decision making. Embodiments of the disclosed invention solve these problems.

### SUMMARY

A communication system is configured to enable node verification. The communication system comprising a company node further comprising a manager validation node communicatively coupled to a decision node. A special purpose acquisition company node is communicatively coupled to the decision node. An investment bank node is communicatively coupled to the decision node. The manager validation node prepares governance, an executive leadership team, audits, and a defensible business model which is communicated to the investment bank node as an offering request.

In some embodiments, the investment bank node rejects the offering request, and the manager validation node engages the special purpose acquisition company node.

In some embodiments, the investment bank node accepts the offering request, and the manager validation node receives funding from the investment bank node before engaging the special purpose acquisition company node.

### BRIEF DESCRIPTION OF THE FIGURES

The detailed description of some embodiments of the invention is made below with reference to the accompanying FIGURES, wherein like numerals represent corresponding parts of the FIGURES.

FIG. 1 shows a schematic view of one embodiment of the present invention;

### DETAILED DESCRIPTION OF CERTAIN EMBODIMENTS

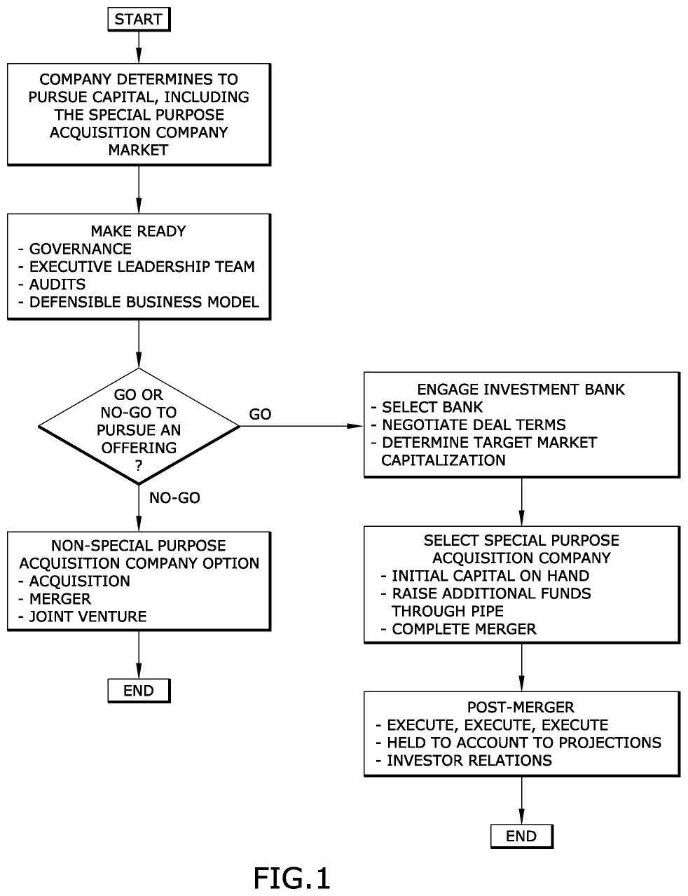

By way of example, and referring to FIG. 1, one embodiment of a communication system is configured to enable node verification. The communication system comprising a company node further comprising a manager validation node communicatively coupled to a decision node. A special purpose acquisition company node is communicatively coupled to the decision node. An investment bank node is communicatively coupled to the decision node. The manager validation node prepares governance, an executive leadership team, audits, and a defensible business model which is communicated to the investment bank node as an offering request.

In some embodiments, the investment bank node rejects the offering request, and the manager validation node engages the special purpose acquisition company node.

In some embodiments, the investment bank node accepts the offering request, and the manager validation node receives funding from the investment bank node before engaging the special purpose acquisition company node.

A company can determine to pursue capital including a special purpose acquisition company. The management team of the company can then prepare a make ready procedure. The make ready procedure includes corporate governance, an executive leadership team, audits, and a defensible business model. Once the make ready procedure is complete a go or no-go decision to pursue an offering involves and path selection between an investment bank and a SPAC.

Turning to the investment bank route, the managers select an investment bank, negotiate deal terms, and determine target market capitalization. Next, the managers select a special purpose acquisition company with the initial capital on hand or to raise additional funds through the pipe. Then the SPAC merges with the company. After the merger, the executive leadership team executes, is held to account projections and investor relations.

If there is no investment bank involved then the SPAC can be acquired, merged into or arranged in a joint venture with the company.

As used in this application, the term “a” or “an” means “at least one” or “one or more.”

As used in this application, the term “about” or “approximately” refers to a range of values within plus or minus 10% of the specified number.

As used in this application, the term “substantially” means that the actual value is within about 10% of the actual desired value, particularly within about 5% of the actual desired value and especially within about 1% of the actual desired value of any variable, element or limit set forth herein.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Any element in a claim that does not explicitly state “means for” performing a specified function, or “step for” performing a specified function, is not to be interpreted as a “means” or “step” clause as specified in 35 U.S.C. § 112, 116. In particular, any use of “step of” in the claims is not intended to invoke the provision of 35 U.S.C. § 112, 116.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A communication system, configured to enable node verification; the communication system comprising:
a company node further comprising a manager validation node communicatively coupled to a decision node;
a special purpose acquisition company node communicatively coupled to the decision node; and
an investment bank node, communicatively coupled to the decision node; and
wherein the manager validation node prepares governance, an executive leadership team, audits, and a defensible business model which is communicated to the investment bank node as an offering request.

2. The communication system of claim 1, wherein the investment bank node rejects the offering request, and the manager validation node engages the special purpose acquisition company node.

3. The communication system of claim 1, wherein the investment bank node accepts the offering request, and the manager validation node receives funding from the investment bank node before engaging the special purpose acquisition company node.
